(19) United States
(12) Patent Application Publication
(10) Pub. No.: US 2004/0070702 A1
(43) Pub. Date: Apr. 15, 2004

(54) Arrangement with flat display units

(75) Inventors: Michael Meyer, Hausen (DE); Peter Schellinger, Marxzell (DE); Reinhold Schneeberger, Seukendorf (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/420,874

(22) Filed: Apr. 23, 2003

(30) Foreign Application Priority Data
Apr. 23, 2002 (DE) 202 06 406.9

(51) Int. Cl. G02F 1/133

(52) U.S. Cl. 349/73; 349/58

(57) ABSTRACT

To show a plurality of individual images, a multi-panel display is used, which includes a plurality of adjacent flat display units. Each unit is provided with a respective housing and each has a display surface. The flat display units have sealant disposed around the housing. In such an arrangement, ambient light behind the multi-panel display is prevented from shining through gaps between adjacent flat display units, which might otherwise cause a distraction for the viewer of the multi-panel display.

The following disclosure is based on German Patent Application No. 20206406.9, filed on Apr. 23, 2002, which is incorporated into this application by reference.

### FIELD OF AND BACKGROUND OF THE INVENTION

The invention relates to an arrangement with at least two adjacently (e.g. vertically and/or horizontally) arranged flat display units, each provided with a housing. The invention further relates to a flat display unit for such an arrangement.

To display a plurality of individual images, a multi-panel display is normally used, which includes several horizontally and vertically arranged flat display units. In such an arrangement, it is possible for ambient light behind the multi-panel display falling through a gap between adjacent flat display units to create a disturbance for a viewer of the display. Such a light gap can be created, for example, if the abutting edges of adjacent flat display units are deformed or if these flat display units are imprecisely positioned.

### OBJECTS OF THE INVENTION

One object of the present invention is to improve an arrangement of the above-mentioned type, in order to obviate the described drawbacks. A further object of the invention is to define a flat display unit that is suitable for such an arrangement.

### SUMMARY OF THE INVENTION

According to one formulation of the invention, these and other objects are attained by an arrangement that includes: at least two adjacently arranged flat display units, each provided with a respective housing and each having a display surface; and sealing means disposed around the housing of each flat display unit substantially parallel to the display surface of the flat display unit. The objects are further addressed by a flat display unit having: a display surface; a housing including a rear housing part and a front housing part; and a sealing means disposed around the housing and substantially parallel to the display surface. According to yet another formulation, the invention is directed to a display panel that has: at least two adjacently arranged modular display units, each having a respective housing and each having a display surface; and a seal extending around the display surface of each modular display unit and sealing with the housing of each modular display unit.

It is advantageous if light gaps between adjacent flat display units are avoided, so that the display surface of the arrangement appears as a homogenous area to a viewer.

According to one embodiment of the invention, a sealant is disposed between a rear part and a front part of the respective housing. Among other advantages, this gives the sealant a firm seat.

### BRIEF DESCRIPTION OF THE DRAWINGS

The invention, its preferred embodiments and its advantages will now be described in greater detail with reference to an exemplary embodiment depicted in the drawing in which

FIG. 1 shows a flat display unit and

FIG. 2 shows a multi-panel display.

### DETAILED DESCRIPTION OF THE PREFERRED EMBODIMENTS

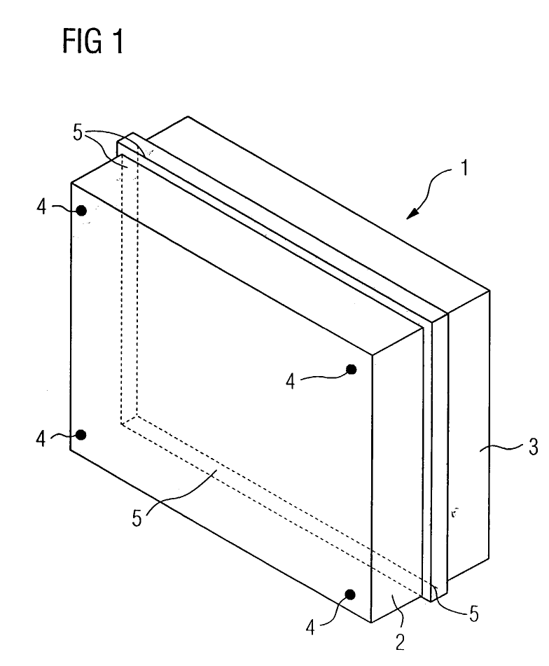

In FIG. 1, the reference numeral 1 designates a flat display unit having a rear and a front housing part 2, 3. The rear and front housing parts 2, 3 are assembled with the aid of fasteners 4. A circumferential seal 5, preferably a seal made of an elastic material, is provided between the rear and the front housing parts 2, 3. As illustrated in FIG. 1, this seal 5 protrudes beyond the housing parts 2, 3 and abuts against a seal of an adjacent flat display unit (not depicted). This prevents ambient light from penetrating between the abutting edges of these flat display units.

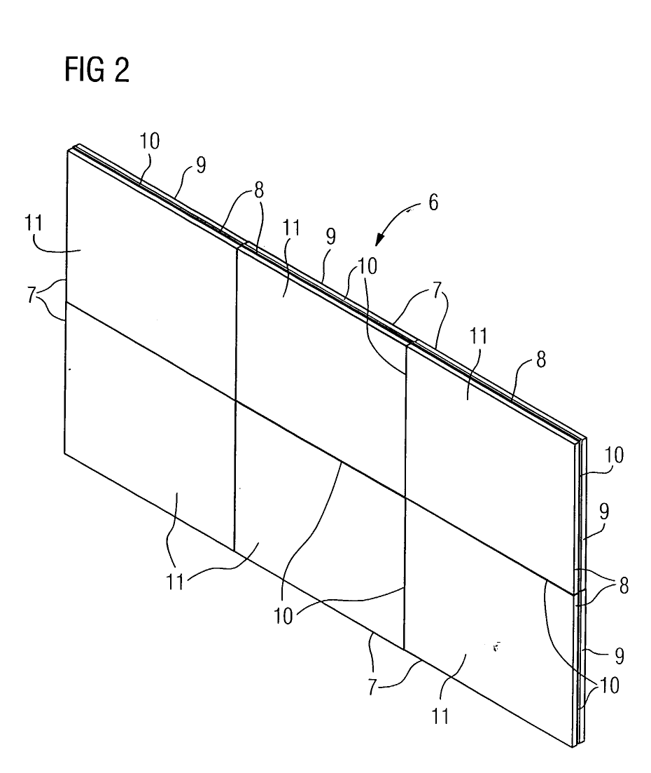

For a more detailed description, reference is now made to FIG. 2, which depicts a multi-panel display 6. The multi-panel display 6 has a plurality of flat display units 7, which are arranged in a 3×2 matrix and each of which is provided with a sealing ring 10. The sealing rings 10 are preferably disposed between a rear housing part 9 and a front housing part 8 of the flat display units 7. The elastic sealing rings 10 of adjacent flat display units 7 preferably abut one another, whereby different gap widths between adjacent flat display units 7 of the multi-panel display 6 are compensated. As a result, a viewer perceives the display faces 11 of the flat display units 7 as a homogenous surface.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. Arrangement comprising:
at least two adjacently arranged flat display units, each provided with a respective housing and each having a display surface; and
sealing means disposed around the housing of each flat display unit substantially parallel to the display surface of the flat display unit.

2. Arrangement as claimed in claim 1, wherein the sealing means is disposed between a rear part and a front part of the respective housing.

3. A flat display unit comprising:
a display surface;
a housing comprising a rear housing part and a front housing part; and
a sealing means disposed around the housing and substantially parallel to the display surface.

4. The flat display unit as claimed in claim 3, wherein the sealing means is disposed between the rear housing part and the front housing part.

5. A display panel comprising:
at least two adjacently arranged modular display units, each having a respective housing and each having a display surface; and
a sealant extending between the two modular display units and sealing with the housing of each modular display unit.

6. The display panel as claimed in claim 5, wherein the modular display units comprise liquid crystal display modules.
